(19) United States
(12) Patent Application Publication
(10) Pub. No.: US 2013/0274011 A1
(43) Pub. Date: Oct. 17, 2013

(54) Electronic Gaming Machine and Gaming Method

(71) Applicant: AINSWORTH GAME TECHNOLOGY LIMITED, Newington (AU)

(72) Inventor: Jason Meyer, Abbotsford (AU)

(21) Appl. No.: 13/792,608

(22) Filed: Mar. 11, 2013

(30) Foreign Application Priority Data
Apr. 16, 2012 (AU) 2012901492

(51) Int. Cl. G07F 17/32

(52) U.S. Cl. CPC G07F 17/3267
USPC 463/31

(57) ABSTRACT

An electronic gaming machine includes a display and an electronic game controller. Two or more first game arrays are played substantially simultaneously. A second array of game enhancing elements is linked to first game arrays selected by the player and is triggered during play of the first game arrays so that the second array awards one or more of the game enhancing elements that modify the games played on the selected first game arrays. A gaming method is also provided.

### BACKGROUND

The present invention relates to an electronic gaming machine and in a particular an electronic gaming machine using a primary game and a secondary bonus game. The invention has been developed primarily for use as an electronic gaming machine and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

One type of electronic gaming machine offers multiple sets of reels to permit a player to play several reels at the same time, depending on the amount that is wagered or bet by the player. For example, a gaming machine could offer four reel sets each having 50 pay lines available for selection by the player. By wagering a suitable amount, such as 200 credits, the player can play all 50 pay lines and thus all four reel sets.

Another type of gaming machine employs are “wheel”-type game concept where a wheel is divided into segments that award a variety of prizes, such as bonus prizes, multipliers, progressive prizes and even free games, as well as non-winning outcomes, such as “bankruptcy” or “lose”. In operation, the wheel spins and the pointer or flipper indicates which segment is won by the player and the associated prize or non-winning outcome. This wheel concept has been extended to mechanical and electronic gaming machines that use multiple wheels in many different formats.

Bonus or “feature” games may be provided by an electronic gaming machine in addition to the base or main game. Typically feature games use the same set of reels as the main game and are limited to a set of free games operated under a single set of rules. This means that the feature game is restricted by the same set of rules, and so there is no variation in the play of the feature game. Consequently, it is difficult to retain player interest because there is no apparent incentive for the player to continue playing the same electronic gaming machine once the player becomes familiar with the feature game and the main game. Also, it is difficult to retain player interest since there is little differentiation between gaming machines in terms of the main and feature games that are played.

It is an object of the present invention to overcome or substantially ameliorate one or more of the disadvantages of prior art, or at least to provide a useful alternative.

It is an object of the invention in at least one preferred form to provide an electronic gaming machine and a method for controlling an electronic gaming machine that encourages player interest.

### SUMMARY

According to a first aspect of the invention, there is provided an electronic gaming machine comprising:

a display for displaying two or more first arrays of game symbols for playing a game, wherein said games on said first arrays are played substantially simultaneously and predetermined winning combinations of randomly selected game symbols in each of said first arrays result in the award prizes to a player, and

an electronic game controller for controlling the display of game symbols on the display, wherein said electronic game controller causes the display of a second array of game enhancing elements,

whereupon said player selecting one or more of said first arrays, said electronic game controller links said second array to said selected first arrays such that in response to a trigger event said electronic game controller causes said second array to award one or more game enhancing elements that modify the games played on said selected first arrays.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Preferably, said one or more game enhancing elements modify the result of each game played on said selected first arrays.

Preferably, the number of said first arrays available for selection depends on the amount of a wager placed by the player.

Preferably, the trigger event occurs on one or more of said first arrays. More preferably, the trigger event comprises a random event determined by said electronic game controller at the start of play of the games on said first arrays.

Alternatively, in one preferred form, the trigger event comprises the appearance of at least one trigger symbol in said first arrays. In another alternative, the trigger event comprises an in-game event during play of the games on said first array.

Preferably, said second array randomly awards said one or more game enhancing elements once the game on each first array is completed. More preferably, said second array individually selects said game enhancing elements for awarding to said player. Where more than one game enhancing element is awarded by said second array, said second array sequentially selects said game enhancing elements for awarding to said player.

Preferably, the second array does not include game enhancing elements that modify the function of said game symbols. More preferably, said game enhancing elements are arranged in said second array without defining any pay lines or predetermined combination of game enhancing symbol positions. In one preferred form, said first arrays comprise pay lines or predetermined combinations of game enhancing symbol positions for determining said predetermined winning combinations. In another preferred form, said second array does not have any game enhancing elements that is a substitute for pay lines, including “ways”, “anys” or “scatters”.

Preferably, said second array displays a proportion of said game enhancing elements.

Preferably, the game enhancing elements comprise at least one or more of a predetermined number of free games, an enhanced second array, bonus prizes, collector symbols, a win multiplier, wild multipliers, bonus wilds, symbols that cause the award of additional free games, trigger symbols to retrigger the second array or enhanced second array, directly retriggering the second array or enhanced second array, held columns, random wild symbols, progressives, bonus credits, jackpot symbols, and one or more symbol replacements.

Held columns or reels typically involve the column or reel to only display wild card symbols, thus enhancing the probability of achieving a predetermined combination. Jackpot symbols typically award a jackpot prize after accumulating a predetermined number of jackpot symbols over a number of games that are played. Progressives operate in a similar manner to jackpot symbols in that a prize is awarded upon a certain number of progressive symbols are accumulated by the player over a number of games played on the gaming machine.

Preferably, said enhanced second array modifies the feature games played on the first arrays. More preferably, said enhanced second array randomly awards one or more game enhancing elements that modify the result of each feature game played on said selected first arrays.

Preferably, the award of free games also triggers replacement of said second array with the enhanced second array, said enhanced second array offering more types of game enhancing elements than said second array. In one preferred form, said enhanced second array modifies the free games played on the first arrays. More preferably, said enhanced second array randomly awards one or more game enhancing elements that modify the result of each free game played on said selected first arrays.

Preferably, at least one of said game enhancing elements comprises the award of free games and the award of free games also triggers replacement of said second array with a plurality of enhanced second arrays so that there is an enhanced second array for each first array. In preferred form, each said enhanced second array modifies the feature games or free games played on their corresponding selected first arrays. More preferably, each said enhanced second array randomly award one or more game enhancing elements that modify the result of each free game played on its corresponding selected first array.

Preferably, the same game is played on said first arrays with the same game symbols. Alternatively, different games are played on each of said first arrays. In this alternative, the same game symbols, different game symbols or a mixture of the same and different game symbols are used in said different games.

Preferably, said first arrays have the same number of game symbols. In another preferred form, said first arrays have different numbers of game symbols. The first arrays may have said game symbols organised or arranged in the same way. In another preferred form, said first arrays may have said game symbols arranged differently to each other.

Preferably, said electronic game controller causes said first arrays to become available for selection by the player.

Preferably, said second array and said enhanced second arrays take any one of a circular, triangular, oval, semi-circular or other non-rectangular shape. In one preferred form, said second array and said enhanced second arrays take the form of partially shown circular wheels. Alternatively, said second array and said enhanced second arrays take the form of visibly rotatable reels.

Preferably, said electronic game controller causes display of said first arrays and said second array during play of a game on said first array. In this preferred form, the change in said second array from being inactive to being active may be indicated on the display. Alternatively, said electronic game controller causes the display of said second array in response to said trigger event.

Preferably, said electronic game controller causes the display of said second array and/or enhanced second arrays on a separate display to said display. Alternatively, said electronic game controller causes the display of said second arrays with said first array on the same display.

Preferably, the player selectively starts and/or stops play of said second array and/or said enhanced second arrays.

According to a second aspect of the invention, there is provided a gaming method for an electronic gaming machine comprising a display and an electronic game controller, the method comprising the steps of:

controllably displaying two or more first arrays of game symbols on said display for playing a game, wherein said games on said first arrays are played substantially simultaneously and predetermined winning combinations of randomly selected game symbols in each of said first arrays award prizes to a player;

controllably displaying a second array of game enhancing elements, and

whereupon the player selecting one or more of said first arrays, linking said second array to said selected first arrays such that in response to a trigger event said electronic game controller causes said second array to award one or more game enhancing elements that modify the games played on said selected first arrays.

Preferably, said method further comprises said one or more game enhancing elements modifying the result of each game played on said selected first arrays.

Preferably, said method further comprises making the number of said first arrays available for selection dependent on the amount of a wager placed by the player.

Preferably, said method further comprises comprising said second array randomly awarding said one or more game enhancing elements once the game on each first array is completed.

Preferably, the method further comprises individually selecting said game enhancing elements from said second array for awarding to said player. More preferably, more than one game enhancing element is awarded by said second array, and the method further comprises sequentially selecting said game enhancing elements from said second array for awarding to said player.

Preferably, said second array does not include game enhancing elements that modify the function of said game symbols. More preferably, the method further comprises arranging said game enhancing elements in said second array without defining any pay lines or predetermined combination of game enhancing symbol positions. In one preferred form, said second array does not have any game enhancing elements that is a substitute for pay lines, including “ways”, “anys” or “scatters”.

Preferably, at least one of said game enhancing elements comprises an enhanced second array, and said method further comprises said enhanced second array modifying the feature games played on the first arrays.

Preferably, at least one of said game enhancing elements comprises an enhanced second array, and said method further comprises said enhanced second array randomly awarding one or more game enhancing elements that modify the result of each feature game played on said selected first arrays.

Preferably, at least one of said game enhancing elements comprises the awarding of free games, said awarding of free games also triggering replacement of said second array with an enhanced second array, said enhanced second array offering more types of game enhancing elements than said second array.

Preferably, at least one of said game enhancing elements comprises the awarding of free games, said awarding of free games also triggering replacement of said second array with a plurality of said enhanced second arrays so that there is an enhanced second array for each first array.

Preferably, said displaying step comprises displaying said first arrays and said second array during play of games on said first arrays. In this preferred form, the change in said second arrays from being inactive to being active may be indicated on the display. Alternatively, displaying step comprises displaying said second arrays in response to said trigger event.

Preferably, the method further comprises causing said first arrays to become available for selection by the player.

Preferably, said method further comprises displaying said second array on a separate display to said display. Alternatively, said method further comprises displaying said second array with said first array on the same display.

The method also preferably has the preferred features of the first aspect of the invention not otherwise stated above.

According to a third aspect of the invention, there is provided a computer system comprising a central processing unit configured for communication with an electronic gaming machine, wherein said computer system is configured to perform the method of the second aspect of the invention.

According to a fourth aspect of the invention, there is provided a computer program configured to perform the method of the second aspect of the invention.

According to a fifth aspect of the invention, there is provided a non-transitive carrier medium carrying computer executable code that, when executed on a central processing unit configured for communication with an electronic gaming machine, causes the central processing unit to perform the method of the second aspect of the invention.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to a first embodiment of the invention;

FIG. 2 is a schematic drawing of an electronic game controller for the electronic gaming machine of FIG. 1;

FIG. 3 is a partial front view of another electronic gaming machine;

FIG. 4 is a schematic drawing of the display of FIG. 3; and

FIG. 5 is a schematic drawing of a display for an electronic gaming machine according to a third embodiment of the invention.

### DETAILED DESCRIPTION OF THE VARIOUS EMBODIMENTS

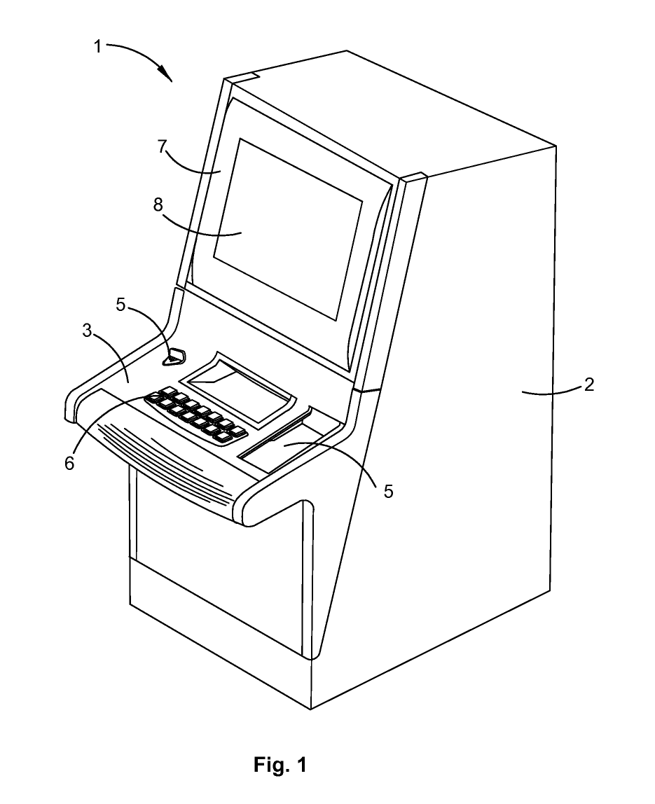

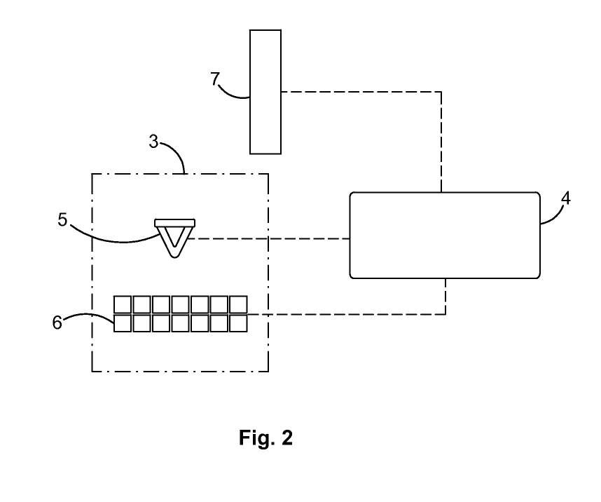

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. The electronic game controller 4 is generally in the form of a central processing unit, such as a computer, and is in electronic communication with a display in the form of a video display screen 7, as well as various input devices on the console 3, as best shown in FIG. 2. It is also appreciated that a person skilled in the art would readily understand the location and use of the electronic game controller 4 in the electronic gaming machine 1.

The video screen 7 may also display other standard game information (not shown), including the number of pay lines available, the number of player-selected pay lines, the amount of credits per line, the amount of player credits the amount of the current bet wagered by the player, the amount of wins by the player, a message area, a general menu button and a current denomination button indicating the currently selected base bet denomination.

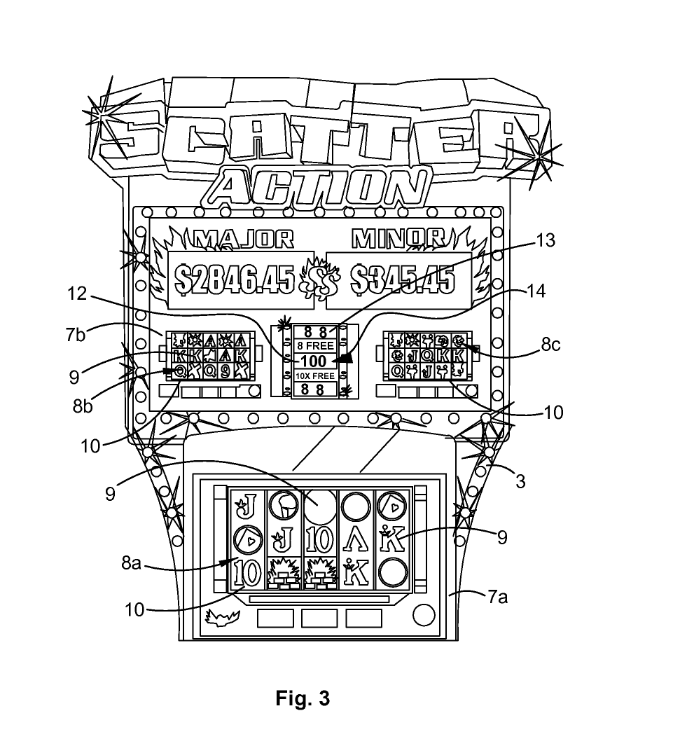

With reference to FIG. 3, an electronic gaming machine 1 according to a second embodiment of the invention is illustrated, where corresponding features have been given the same reference numerals. The difference between this embodiment and the first embodiment is that display 7 is in the form of a main video screen 7a and a secondary video screen 7b, which are used to display two or more first arrays 8a, 8b, 8c of game symbols 9 for playing a game on each first array.

The games on the first arrays 8a, 8b, 8c are played substantially simultaneously and predetermined winning combinations of randomly selected game symbols in each of the first arrays 8a, 8b, 8c result in the award prizes to a player. Each first array 8a, 8b, 8c of game symbols 9 is arranged in the form of three rows and five columns or “reels” 10. However, the games offered by each first array 8a, 8b, 8c are different to each other. For example, the first array 8a may offer the “Mustang Money”™ game, the first array 8b may offer the “Money Heat”™ game and the first array 8c may offer the “Dolphins”™ game. Each game offered on the first arrays 8a, 8b, 8c is unique in presentation, pay table and game rules. The game symbols 9 used in each game typically include picture symbols, wild symbols, scatter symbols and card symbols. These game symbols may be shared or exclusive to that particular game.

The secondary screen 7b located above the main video screen 7a also displays a second array 12 of game enhancing elements in the form of symbols 13 arranged as a single reel with a pointer 14 for indicating the game enhancing element to be selected during activation of the second array 12. The game enhancing symbols 13 include, for example, “Held Reels”, “×10 Multiplier”, “10 Free Spins” and “Jackpot” symbols. These game enhancing symbols 13 are different in nature to the game symbols 9 on the first arrays 8a, 8b, 8c as they are not combined with the game symbols 9 to form winning combinations but are used to modify play of the games on the first arrays. In other words, the game enhancing symbols 13 exclude the game symbols 9 used in the first arrays 8a, 8b, 8c. The second array 12 represents a wheel partially shown on the secondary video screen 7b so as to display five fully shown game enhancing symbols 13 and two partially shown game enhancing symbols at a time.

The electronic game controller controls the display of the first arrays 8a, 8b, 8c and the second array 12. In response to a trigger event during play of any of the games on the first arrays 8a, 8b, 8c, the electronic game controller causes the first arrays 8 to become available for selection by the player. Once the player has selected one or more of the first arrays 8a, 8b, 8c, the electronic game controller links the second array 12 to the selected first arrays such that the second array awards one or more game enhancing symbols 13 that modify one or more subsequent games played on the selected first arrays. The number of first arrays 8a, 8b, 8c that become available for selection depends on the amount of the wager made by the player.

While the first arrays 8a, 8b, 8c are arranged with five columns or “reels” 10 and three rows, it will be appreciated by one skilled in the art that other types of arrays could be used, such as 3×3, 4×3, 5×5, 4×4, etc, including arrays having an irregular number of rows and/or columns. Each first array 8a, 8b, 8c defines predetermined game positions or “squares” 14. Each of the first arrays 8a, 8b, 8c are arranged so that a player can select one or more predetermined “pay lines” 15 defined around the array, which correspond to combinations of the game positions 14. The pay lines 15 generally comprise at least one game position 14 from each reel 10. The number of pay lines 15 that can be selected by the player depends on the amount of the monetary bet for playing a game on each first array 8a, 8b, 8c.

This is in contrast to the second array 12, which arranges the game enhancing elements or symbols 13 around the wheel in a random or preset pattern without defining any pay lines or predetermined combination of game enhancing symbol positions. In other words, the second array 12 does not award game enhancing elements using combinations of game enhancing symbols 13 on the wheel. Also, the wheel 12 does not have any game enhancing symbol 13 that is a substitute for pay lines such as industry known winning patterns like “ways”, “anys” or “scatters”. Thus, only the first arrays comprise pay lines or predetermined combinations of game enhancing symbol positions for determining said predetermined winning combinations.

When a game is played on each first array, the controller causes the reels 10 on each first array 8a, 8b, 8c to appear to visibly rotate or “spin”, and randomly display the game symbols 9 in each game square 14. After the reels 10 stop spinning, the controller determines whether there are any predetermined winning combinations of the game symbols 9 appearing in any player-selected pay lines 15, such as a two of a kind, three of a kind, four of a kind or five of a kind. It will be appreciated that other winning combinations of game symbols 9 can also be provided. If so, the gaming machine 1 enters a winning game state and awards a prize according to the displayed predetermined winning combination.

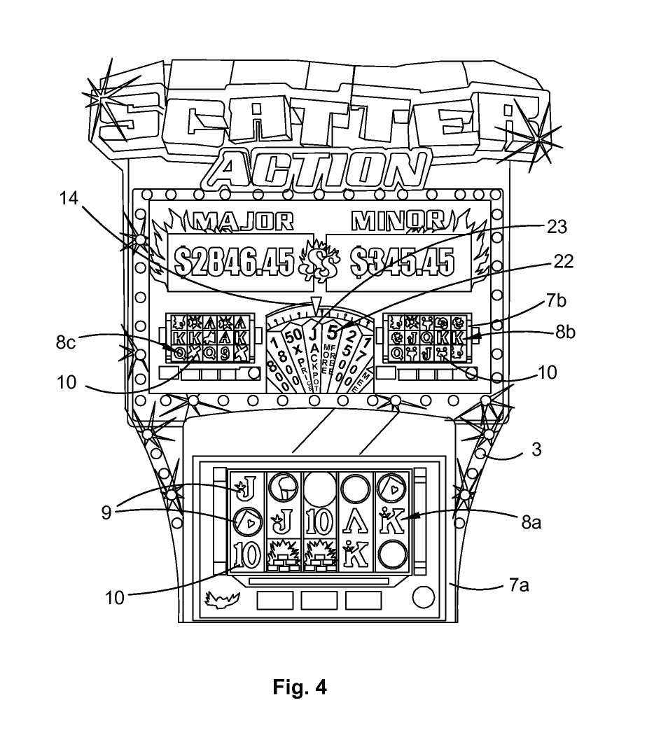

Operation of the first embodiment of the invention will now be described in more detail with reference to an example, best shown in FIGS. 3 and 4. Referring to FIG. 3, the displays 7a, 7b indicate to the player the three first arrays 8a, 8b, 8c that can be played on the electronic gaming machine 1.

In this embodiment, the first arrays 8a, 8b, 8c offer different games to each other. Generally, the different games would have game symbols 9, game rules and pay tables that are unique to each game. However, some game symbols 9 can be shared amongst the games played on the first arrays 8a, 8b, 8c. In an alternative embodiment, the first arrays 8a, 8b, 8c share the same game symbols 9. In a further alternative, the first arrays 8a, 8b, 8c have exclusive sets of game symbols 9.

Initially, the player has three bet or wager options in which to play the first arrays 8a, 8b, 8c on the electronic gaming machine. For a first bet option of 50 credits, the player can select one of the first arrays 8a, 8b, 8c to be played for one game, in combination with the wheel 12. A second bet option of 100 credits permits the player to select two of the first arrays 8a, 8b, 8c to be played for one game in each first array, in combination with the second array, in the form of wheel 12. A third bet option of 150 credits enables the player to select all three first arrays 8a, 8b, 8c to be played for one game in each first array, in combination with the wheel 12. The player may also choose to increase the initial number of pay lines that are can played in each of the selected first arrays 8a, 8b, 8c by making additional bets or wagers for each first array.

Once the player has made his or her selection, the electronic game controller causes the selected first arrays 8a, 8b, 8c visually rotate or spin for each game that is played, while the wheel 12 activated upon the occurrence of a trigger event. The electronic game controller ensures that the trigger event occurs on average once in every 30 games played on the selected first arrays 8a, 8b, 8c.

In this embodiment, the electronic game controller randomly determines whether the trigger event occurs at the beginning of a spin of each first array 8 that has been selected for play. If the random trigger event does occur, the wheel 12 is activated and the electronic game controller causes the machine 1 to issue a recognisable and memorable wheel trigger sound to the player to indicate that the wheel 12 is now active.

Once the wheel 12 is triggered, all the selected first arrays 8a, 8b, 8c and the wheel 12 will spin simultaneously. Each of the selected first arrays 8a, 8b, 8c will then stop sequentially and the wheel 12 stops only when all the selected first arrays 8a, 8b, 8c have completed their spins. This sequentially stopping with the wheel 12 stopping last builds anticipation within the player and causes him or her to focus on the outcome of the spin of the wheel 12, enhancing the player's interest and excitement.

At completion of the spin of the wheel 12, the pointer 14 indicates which game enhancing symbol 13 fully shown on the wheel has been awarded to the player. The game enhancing symbols 13 that can be won with wheel 12 include:
i) 15 Free Games;
ii) 10 Free Games;
iii) 8 Free Games;
iv) Bonus Prize of 5× bet;
v) Bonus Prize of 10× bet;
vi) Bonus Prize of 25× bet;
vii) All royal card symbols change to wilds on reels 2, 3 and 4 of each selected first array;
viii)All picture symbols change to wilds on reels 2, 3 and 4 of each selected first array;
ix) All symbols on reels 2 and 4 of each selected first array change to wild symbols; and
x) All symbols on reels 1 and 5 4 of each selected first array change to wild symbols.

These game enhancing symbols 13 do not modify the function or value of the game symbols 9 that appear on the first arrays, but instead confer bonus prizes, free games or change existing game symbols for other game symbols (such as replacing picture, royal card or symbols belonging to a reel with wild symbols).

The electronic game controller also pays out any wins that have occurred on any selected pay lines of the games played on the selected game arrays 8a, 8b, 8c, thus concluding the game unless the game enhancing symbol 13 that has been awarded is a predetermined number of free spins on the selected first arrays 8a, 8b, 8c. These free spins form a “feature” game for the “base” games played on the first arrays 8a, 8b, 8c. In this embodiment, there are 3 free spin game enhancing symbols 13 that confer 8, 10 or 15 free spins on the selected first arrays 8a, 8b, 8c.

The feature game is illustrated in FIG. 4, where corresponding features have been given the same reference numerals. During play of the 8, 10 or 15 free spins on the selected first arrays 8a, 8b, 8c, the wheel 12 is replaced with an enhanced wheel 22 that is active for each free spin. The enhanced wheel 22 provides additional game enhancing symbols 23 that include the award of points or an additional 5 free spins of the selected first arrays 8a, 8b, 8c (i.e. retriggering 5 more free spins).

The collection of points awarded by the enhanced wheel 22 during free spins or game leads to the trigger of additional prizes or game enhancing symbols, depending on the number of points that are collected. These additional prizes include stand alone progressive jackpots, bonus prizes and super games, which are enhanced versions of free spins or games where there are greater pay outs or frequency of wins. In this embodiment the point system and their additional prizes are set out in the table below.

| Number of | |
|---|---|
| points collected | |
| during free spins | Additional prize |
| 1 to 3 | Bonus prize of 3 × bet |
| 4 | Bonus prize of 5 × bet |
| 5 | Bonus prize of 10 × bet |
| 6 | 1 free spin of a Super Game |
| 7 | 2 free spins of a Super Game |
| 8 | Minor Progressive jackpot (at max bet or 50 × bet) |
| 9 | Major Progressive jackpot (at max bet or 100 × bet) |
| 10 | Grand Progressive jackpot (at max bet or 250 × bet) |

The amounts of the minor progressive jackpot 30 and major progressive jackpots 31 are displayed on the video screen 7b during play of the base game and the feature game, as best shown in FIGS. 3 and 4.

In addition, the enhanced wheel 22 is accompanied by animations and sounds to indicate to the player that the enhanced wheel 22 is active for the feature game. The enhanced wheel 22 also has a different visual representation to the wheel 12 in the form of a partial front view, as best shown in FIG. 4, compared to the partial side or end view of the wheel 12, as best shown in FIG. 3.

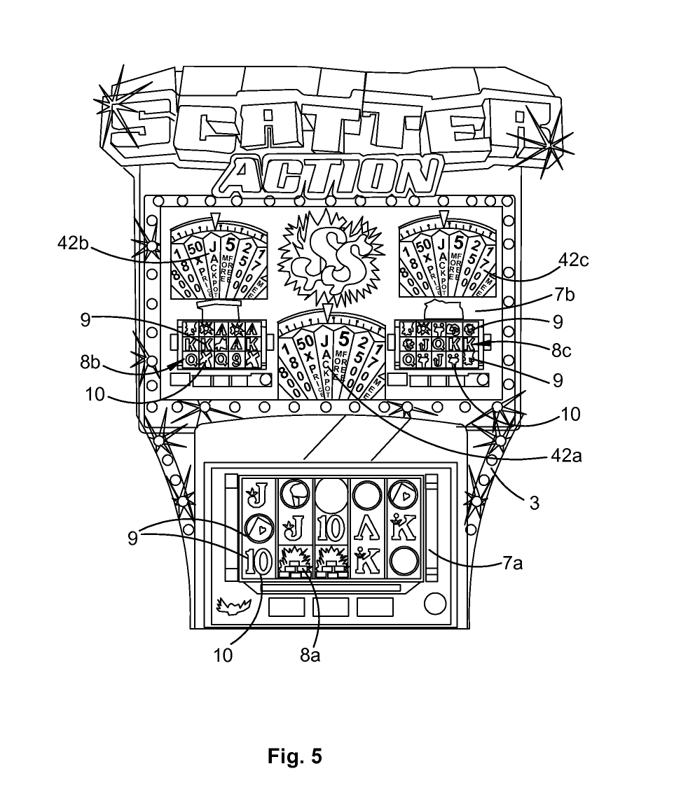

Another embodiment of the invention is illustrated in FIG. 5, where corresponding features have been given the same reference numerals. In this embodiment, the base game is the same as described in relation to FIG. 3. However, the feature game in this embodiment provides individual enhanced wheels 42a, 42b, 42c for each selected first array 8a, 8b, 8c. The enhanced wheels 42a, 42b, 42c provide the same game enhancing symbols 13 as described in relation to the first embodiment, but the game enhancing symbols are limited to the selected first array 8a, 8b, 8c that is associated with the enhanced wheel 42a, 42b, 42c.

The grand progressive jackpot is confined to the electronic gaming machine 1. However, in another preferred form, the grand progressive jackpot is configured to be part of a wide area or in-house link progressive jackpot. In other words, the grand progressive jackpot can be awarded on a group of networked gaming machines in a specified area or a group of specified electronic gaming machines that are linked together for jackpot purposes.

In both variations, the enhanced second arrays 22, 42a, 42b, 42c is triggered more frequently or every feature game played on the first arrays 8a, 8b, 8c compared to the second array 12 in the base game, which would be approximately on average once every 30 games. This would increase the excitement of the feature game compared to the base game.

It can be seen that the provision of player-selected first arrays whose games can be modified by game enhancing elements awarded by the second array enhances player excitement and anticipation, since the outcomes of the game(s) played on the selected first arrays can vary depending on the outcome of a spin of the second array that occurs randomly. This unpredictable variety in game play increases the likelihood that a player will prefer to continue playing the same electronic gaming machine.

Although the preferred embodiments of the invention have been described as awarding a specific number and types of game enhancing elements, it will be appreciated that the wheels 12, 22, 42a, 42b, 42c can be configured to award any number or types of game enhancing elements. Also, where the wheels 12, 22, 42a, 42b, 42c each award more than one game enhancing element 13, the game enhancing elements are individually selected one at a time. In other words, the game enhancing elements are selected sequentially. In addition, the enhanced wheels 22, 42a, 42b, 42c may provide game enhancing symbols 23, 43 of greater value and/or frequency compared to the wheel 12.

Moreover, the second arrays 12, 22, 42a, 42b, 42c can randomly award the game enhancing elements 13 or can award certain game enhancing elements depending on the history of previously awarded game enhancing elements.

In one preferred form, the invention provides free spins that can be won by the player on either the games played on the selected first arrays 8 or by the wheel 12. In another preferred form, depending on the type of game enhancing element 13 that has been won, it can be either applied immediately to the game outcome on the first arrays 8a, 8b, 8c or saved for one or more future games played on the selected first arrays 8a, 8b, 8c.

In other preferred forms of the invention, the trigger event is the appearance of a predetermined number of trigger symbols on any of the selected first arrays 8a, 8b 8c, a predetermined combination of symbols or any other predefined event during game play.

Also, the second array 12 can be optionally purchased by the player as a side bet, or offered complimentary when any game is played when a certain threshold is bet or a max bet is made by the player.

While the preferred embodiment of the invention has been described in relation to a main game and a feature game, those skilled in the art will appreciate that the game enhancing elements can readily be applied to the main game in addition to a feature or bonus game. Alternatively, there is no feature or bonus game and instead the game enhancing elements modify the main game for a predetermined number of games played in the main game. These games may be free or require payment from the player.

In another preferred form, the game enhancing symbols 13 may indicate the duration in which its game enhancing element is applied, such as a predetermined number of spins or a predetermined time period.

Also, in a further preferred form, the player can selectively stop spinning of the wheels 12, 22, 42a, 42b, 42c to increase player interaction and provide the player with an opportunity to guess when a desired game enhancing symbol 13 may appear at the pointer 14. Furthermore, the player can start spinning of the wheels 12, 22, 42a, 42b, 42c to further enhance player interaction.

In other preferred forms, the first arrays 8a, 8b, 8c and the second array 12, 22, 42a, 42b, 42c need not be displayed on separate screens 7a, 7b. Instead, they may be displayed on a single screen. Also, the second array 12 may not appear on the video screen 7a until the player makes his or her selection of the first arrays 8a, 8b, 8c.

In another preferred form, the video screens 7a, 7b are touch screens for use in addition to the player-actuatable buttons 5 so as to enable the player to select various features, such as making monetary bets for the game, selection of the first arrays 8a, 8b, 8c, initiating play of the games played on the selected first arrays 8a, 8b, 8c and responding to any messages or requests issued on the electronic gaming machine 1 by the electronic game controller. In this case, the player may control when the second arrays or wheels 12, 22, 42a, 42b, 42c start spinning and stop spinning by simply touching the relevant second array or wheel 12.

In other preferred forms, the first arrays 8 and/or the second arrays 12 have other features like jackpot prizes. The jackpot prize can be shared with any other games offered on the electronic gaming machine (as in multi-game gaming machines) or games offered on separate electronic gaming machines. Information relating to the jackpot prize(s) can be provided on the screen 7 or via an additional top screen that is devoted to displaying jackpot information. The top screen ensures that the jackpot information is available to the player at all times during play of the electronic gaming machine 1. In one preferred form, the jackpot prize comprises a mystery jackpot. That is, none of the symbols in the game trigger the jackpot; hence the triggering event is a “mystery”. By way of comparison, a standard jackpot is typically symbol driven in that a particular combination of symbols must occur in the game to trigger the standard jackpot.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer program configured to perform the invention. In this way the invention can be implemented in various ways on an electronic gaming machine. In a further aspect, the invention includes a computer system configured comprising a central processing unit configured for communication with an electronic gaming machine to perform the invention. In a yet another aspect, the invention includes a non-transitive carrier medium carrying computer executable code that, when executed on a central processing unit configured for communication with an electronic gaming machine, causes said central processing unit to perform the invention. In this case, the non-transitive carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of the player being able to selectively starting or stopping spinning of the second arrays or wheels 12, 22, 42a, 42b, 42c and the feature of the game enhancing element 13 that has been won being saved for one or more future games played on the selected first arrays 8a, 8b, 8c can be combined into a single electronic gaming machine. Similar combinations of two or more features from the above described embodiments or preferred forms of the invention can be readily made by one skilled in the art.

By providing a second array having game enhancing elements that can be triggered by any one of the simultaneous games played on the first arrays, the player's anticipation and excitement is heightened as there is more opportunity to activate the second array. The player's excitement and anticipate is also heightened by the second array being able to confer game enhancing elements that render each completed game outcome unique and variable between each play of the first arrays. Also, the provision of enhanced second arrays in the preferred embodiments of the invention provides more variety, and thus generates more player interest, by providing a greater variety of game enhancing elements than those game enhancing elements traditionally offered by conventional electronic gaming machines. Collecting points via special game enhancing symbols to obtain minor, major and grand progressive jackpots based upon the accumulated value of more than one first array increases the potential value of wins in the feature game. This is a distinct advantage over conventional electronic gaming machines that only provide win multipliers, free games, credit prizes or progressive symbols.

The invention also adds greater value to a player in terms of the probability of winning a prize relative to the amount bet or wagered, especially compared to a conventional electronic gaming machine that only has one set of reels and a single feature game. This value to the player is increased in the preferred embodiments of the invention by extending play of the second array to the feature game in addition to the base game.

All these advantages of the invention result in the player being more likely to retain interest in continuing to play the same electronic gaming machine due to the variation in game play on the gaming machine. Furthermore, since the electronic game controller controls operation of the first and second arrays, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a display for displaying two or more first arrays of game symbols for playing a game, wherein said games on said first arrays are played substantially simultaneously and predetermined winning combinations of randomly selected game symbols in each of said first arrays result in the award prizes to a player, and
an electronic game controller for controlling the display of game symbols on the display, wherein said electronic game controller causes the display of a second array of game enhancing elements,
whereupon the player selecting one or more of said first arrays, said electronic game controller links said second array to said selected first arrays such that in response to a trigger event said electronic game controller causes said second array to award one or more game enhancing elements that modify the games played on said selected first arrays.

2. The electronic gaming machine of claim 1, wherein said one or more game enhancing elements modify the result of each game played on said selected first arrays.

3. The electronic gaming machine of claim 1, wherein the number of said first arrays available for selection depends on the amount of a wager placed by the player.

4. The electronic gaming machine of claim 1, wherein said trigger event occurs on one or more of said first arrays.

5. The electronic gaming machine of claim 1, wherein said second array randomly awards said one or more game enhancing elements once the game on each first array is completed.

6. The electronic gaming machine of claim 1, wherein said second array individually selects said game enhancing elements for awarding to said player.

7. The electronic gaming machine of claim 1, wherein more than one game enhancing element is awarded by said second array, and said second array sequentially selects said game enhancing elements for awarding to said player.

8. The electronic gaming machine of claim 1, wherein said second array does not include game enhancing elements that modify the function of said game symbols.

9. The electronic gaming machine of claim 8, wherein said game enhancing elements are arranged in said second array without defining any pay lines or predetermined combination of game enhancing symbol positions.

10. The electronic gaming machine of claim 8, wherein said second array does not have any game enhancing elements that is a substitute for pay lines, including “ways”, “anys” or “scatters”.

11. The electronic gaming machine of claim 1, wherein said game enhancing elements comprise at least one or more of a predetermined number of free games, an enhanced second array, bonus prizes, collector symbols, a win multiplier, wild multipliers, bonus wilds, symbols that cause the award of additional free games, trigger symbols to retrigger the second array or enhanced second array, directly retriggering the second array or enhanced second array, held columns, random wild symbols, progressives, bonus credits, jackpot symbols, and one or more symbol replacements.

12. The electronic gaming machine of claim 1, wherein at least one of said game enhancing elements comprises an enhanced second array, and said enhanced second array modifies the feature games played on the first arrays.

13. The electronic gaming machine of claim 1, wherein at least one of said game enhancing elements comprises an enhanced second array, and said enhanced second array randomly awards one or more game enhancing elements that modify the result of each feature game played on said selected first arrays.

14. The electronic gaming machine of claim 1, wherein at least one of said game enhancing elements comprises the award of free games and said award of free games also triggers replacement of said second array with an enhanced second array, said enhanced second array offering more types of game enhancing elements than said second array.

15. The electronic gaming machine of claim 1, wherein at least one of said game enhancing elements comprises the award of free games and said award of free games also triggers replacement of said second array with a plurality of said enhanced second arrays so that there is an enhanced second array for each first array.

16. A gaming method for an electronic gaming machine comprising a display and an electronic game controller, the method comprising the steps of:
controllably displaying two or more first arrays of game symbols on said display for playing a game, wherein said games on said first arrays are played substantially simultaneously and predetermined winning combinations of randomly selected game symbols in each of said first arrays award prizes to a player;
controllably displaying a second array of game enhancing elements, and
whereupon the player selecting one or more of said first arrays, linking said second array to said selected first arrays such that in response to a trigger event said electronic game controller causes said second array to award one or more game enhancing elements that modify the games played on said selected first arrays.

17. The gaming method of claim 16, said method further comprising said one or more game enhancing elements modifying the result of each game played on said selected first arrays.

18. The gaming method of claim 16, said method further comprising making the number of said first arrays available for selection dependent on the amount of a wager placed by the player.

19. The gaming method of claim 16, said method further comprising said second array randomly awarding said one or more game enhancing elements once the game on each first array is completed.

20. The gaming method of claim 16, the method further comprising individually selecting said game enhancing elements from said second array for awarding to said player.

21. The gaming method of claim 16, wherein more than one game enhancing element is awarded by said second array, said method further comprises sequentially selecting said game enhancing elements from said second array for awarding to said player.

22. The gaming method of claim 16, said method further comprising arranging said game enhancing elements in said second array without defining any pay lines or predetermined combination of game enhancing symbol positions.

23. The gaming method of claim 16, wherein said second array does not include game enhancing elements that modify the function of said game symbols.

24. The gaming method of claim 23, wherein said second array does not have any game enhancing elements that is a substitute for pay lines, including “ways”, “anys” or “scatters”.

25. The gaming method of claim 16, wherein at least one of said game enhancing elements comprises an enhanced second array, said method further comprising said enhanced second array modifying the feature games played on the first arrays.

26. The gaming method of claim 16, wherein at least one of said game enhancing elements comprises an enhanced second array, said method further comprising said enhanced second array randomly awarding one or more game enhancing elements that modify the result of each feature game played on said selected first arrays.

27. The gaming method of claim 16, wherein at least one of said game enhancing elements comprises the awarding of free games, said awarding of free games also triggering replacement of said second array with an enhanced second array, said enhanced second array offering more types of game enhancing elements than said second array.

28. The gaming method of claim 16, wherein at least one of said game enhancing elements comprises the awarding of free games, said awarding of free games also triggering replacement of said second array with a plurality of said enhanced second arrays so that there is an enhanced second array for each first array.

29. A computer system comprising a central processing unit configured for communication with an electronic gaming machine, wherein said computer system is configured to perform the method of claim 16.

30. A computer program configured to perform the method of claim 16.

31. A non-transitive carrier medium carrying computer executable code that, when executed on a central processing unit configured for communication with an electronic gaming machine, causes said central processing unit to perform the method of claim 16.
